(19) United States
(12) Patent Application Publication
(10) Pub. No.: US 2008/0268690 A1
(43) Pub. Date: Oct. 30, 2008

(54) Memory Card Connector

(75) Inventors: Jing Lu, Jiangsu Prov (CN); San-Shan Huang, Taipei (TW)

Correspondence Address: MOLEX INCORPORATED, 2222 WELLINGTON COURT, LISLE, IL, 60532, US

(73) Assignee: MOLEX INCORPORATED, LISLE, IL (US)

(21) Appl. No.: 11/587,121

(22) PCT Filed: Apr. 18, 2005
(86) PCT No.: PCT/US05/13278

§ 371 Date: Aug. 16, 2007

(30) Foreign Application Priority Data
Apr. 20, 2004 (CN) 200420042441.X
Apr. 20, 2004 (CN) 200420042442.4

(51) Int. Cl. H01R 13/625

(52) U.S. Cl. 439/345

(57) ABSTRACT

A memory card connector includes a dielectric housing having at least one terminal-receiving slot. A conductive terminal is mounted in the slot and includes a generally U-shaped section defining a fixing leg and a contact leg joined by a spring bend. The fixing leg is fixed to the housing. The contact leg is resiliently flexible and has a contact portion for engaging a contact on a memory card. A latch mechanism is interengaged between the fixing leg and the contact leg for preloading the resiliently flexible contact leg with a preload force while allowing the contact leg to flex upon engagement with the memory card.

### FIELD OF THE INVENTION

This invention generally relates to the art of electrical connectors and, particularly, to a memory card connector.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card, itself, writes or reads via the connector and can transmit between electrical appliances, such as a word processor, personal computer, personal data assistant or the like. The card may be used in applications such as mobile or cellular telephones which are actuated and permit data access after identifying an identification code stored on a SIM (subscriber identification module) card. The SIM card has a conductive face with an array of contacts, and the mobile phone has a SIM card connector with terminals for electrical connection with the contacts of the SIM card to ensure the subscriber identification confirmation.

FIG. 1 shows a prior art memory card connector as disclosed in U.S. Pat. No. 6,231,394. The connector includes a dielectric housing 10 having a plurality of terminal-receiving slots 12 for receiving a plurality of conductive terminals 14. FIG. 2 shows that each conductive terminal 14 includes a solder tail portion 16 joined to a generally U-shaped section formed by a first leg 18 which is joined to a second leg 20 by a bent portion 22. The solder tail portion 16 is flat for solder connection to a printed circuit board (not shown) by surface mounting technology. First leg 18 is used to fix the terminal within a respective one of the slots 12 in housing 10. Second leg 20 is resiliently flexible in the direction of double-headed arrow “A” in FIG. 2. The second leg terminates in a dome-shaped contact portion 24 which projects upwardly out of the housing as can be seen in FIG. 1, for contacting a conductive surface of a memory card. Contact portion 24 and flexible leg 20 are preloaded with a preload force by means of a pair of wings 26 of the terminal being captured beneath a plurality of shoulders 28 of housing 10 as can be seen in FIG. 1. Therefore, as the terminals are mounted into slots 12 in the direction of arrow “B” (FIG. 1), legs 20 and contact portions 24 are flexed downwardly so that wings 26 seat beneath shoulders 28 to preload the contact portions.

While prior art connectors of the type shown in FIGS. 1 and 2 are adequate for their intended purposes, the preloading system requires that the housing be used to preload the terminals. This increases the height of the housing and does not lend the connector to a low profile. The present invention is directed to solving these problems by providing a unique preloading system of the terminals and which facilitates the provision of a low profile connector.

### SUMMARY OF THE INVENTION

An object, therefore, of the invention is to provide a memory card connector of the character described, including a new and improved system for preloading the terminals of the connector.

In the exemplary embodiment of the invention, the memory card connector includes a dielectric housing having at least one terminal-receiving slot. A conductive terminal is mounted in the slot and includes a generally U-shaped section defining a fixing leg and a contact leg joined by a spring bend. The fixing leg is fixed to the housing. The contact leg is resiliently flexible and has a contact portion for engaging a contact on a memory card. Latch means are interengaged between the fixing leg and the contact leg for preloading the resiliently flexible contact leg with a preload force while allowing the contact leg to flex upon engagement with the memory card.

Therefore, no portions of the connector housing are used to preload the terminals of connector.

According to some aspects of the invention, the fixing leg extends from the spring bend to a distal end forming a tail portion for connection to an appropriate printed circuit board. The contact leg extends from the spring bend to a distal end which forms the contact portion. The contact leg is cantilevered over the fixing leg and, in one embodiment of the invention, the contact portion is rounded and projects outwardly from the contact leg.

According to other aspects of the invention, the latch means are interengaged between adjacent side edges of the fixing and contact legs. Preferably, the latch means are engaged between adjacent side edges of the legs at both opposite sides of the legs. As disclosed herein, the latch means comprises a latch hook located at least at one side edge of one of the fixing or contact legs latchingly interengaged with a latch wing projecting from a side edge of the other of the fixing or contact legs.

According to further aspects of the invention, the contact leg has an inwardly bent distal end projecting toward the fixing leg, and the fixing leg has a hole into which the inwardly bent distal end of the contact leg can move upon engagement of the contact leg with the memory card. The fixing leg has a solder tail portion for solder connection to a surface of an appropriate printed circuit board. The solder tail portion has a through hole through which solder material can flow to a top surface of the solder tail portion.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIGS. 1 and 2 are views of a prior art memory card connector as described in the Background, above;

FIG. 3 is a top perspective view of a first embodiment of a memory card connector embodying the concepts of the invention;

FIG. 4 is a top perspective view of one of the terminals of the connector in FIG. 3;

FIG. 5 is a bottom plan view of the terminal in FIG. 4;

FIGS. 6 and 7 are views similar to that of FIGS. 3 and 4, respectively, but of a second embodiment of the invention; and

FIG. 8 is an end elevational view of the terminal in FIG. 7.

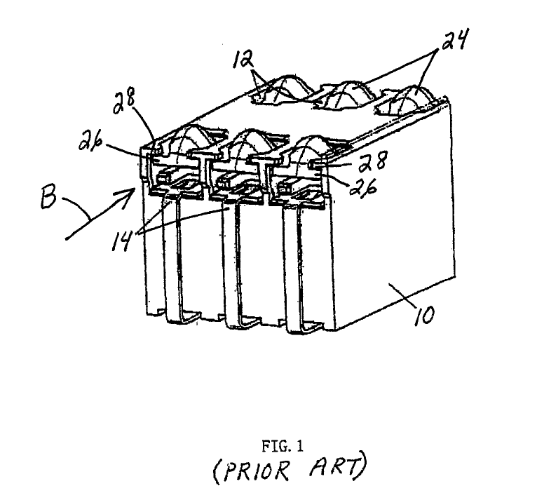

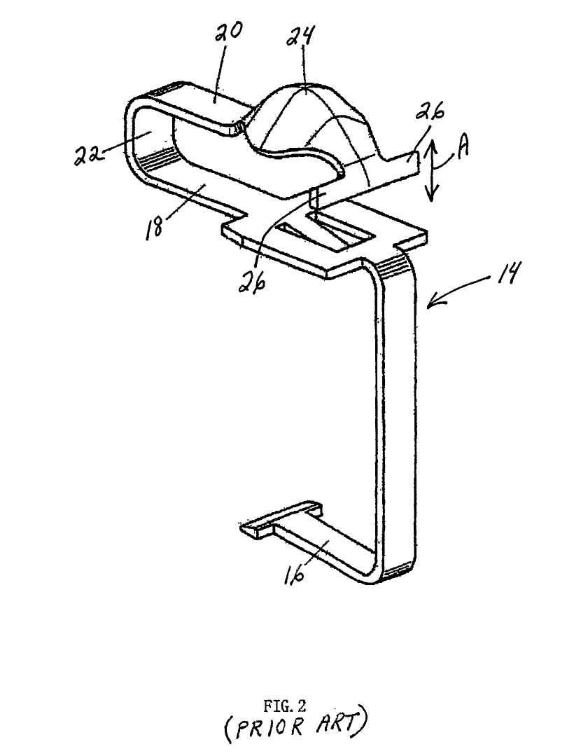

### DETAILED DESCRIPTION OF THE PREFERRED EMBODIMENTS

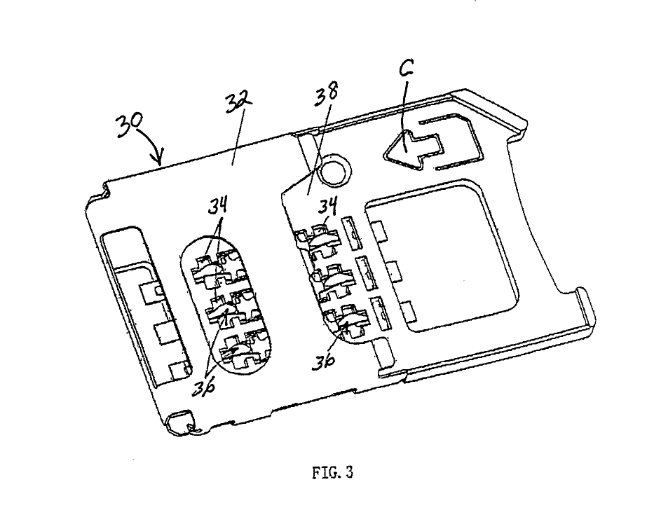

Referring to the drawings in greater detail, and first to FIG. 3, a first embodiment of the invention is incorporated in a memory card connector, generally designated 30, which includes a dielectric housing 32 having a plurality of terminal-receiving slots 34 which mount a plurality of conductive terminals, generally designated 36. The housing has a mating face 38 against which a memory card (not shown) is inserted in the direction of arrow “C”.

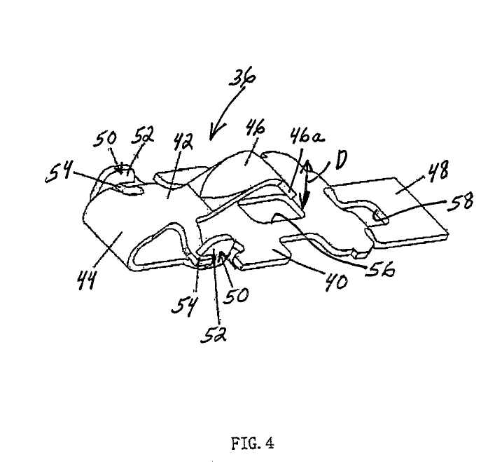

Referring to FIG. 4, each terminal 36 is stamped and formed of conductive sheet metal material and includes a generally U-shaped section which defines a fixing leg 40 and a contact leg 42 joined by a spring bend 44. Fixing leg 40 is used to fix the terminal in a respective one of the terminal-receiving slots 34 of housing 32. Contact leg 42 is cantilevered over the fixing leg and is resiliently flexible toward and away therefrom in the direction of double-headed arrow “D”. The contact leg extends from spring bend 44 to a distal end which forms a rounded contact portion 46 for engaging a contact on the memory card. Fixing leg 40 extends from the spring bend to a distal end which forms a tail portion 48 for connection to an appropriate printed circuit board.

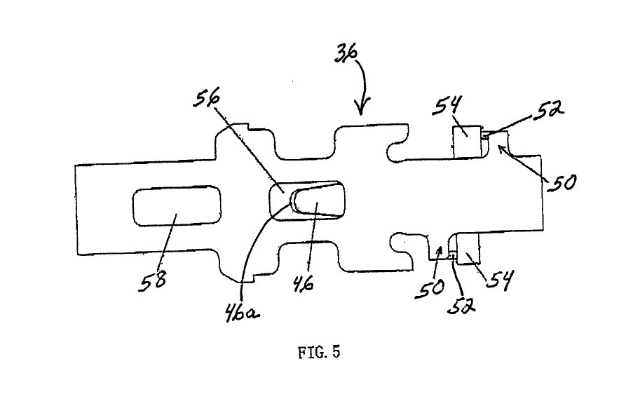

Referring to FIG. 5 in conjunction with FIG. 4, a latch means, generally designated 50, is interengaged between the fixing leg and the contact leg at adjacent side edges of the legs at both opposite sides of the legs. Generally, the latch means is provided for preloading the resiliently flexible contact leg 46 with a preload force while allowing the contact leg to flex (arrow “D”) upon engagement with the memory card, keeping in mind that fixed leg 40 is fixed to the connector housing.

More particularly, each latch means 50 includes a latch hook 52 bent upwardly from a side edge of fixing leg 40. The latch hook is latchingly interengaged with a latch wing 54 which projects laterally outwardly from an adjacent side edge of contact leg 42. A pair of latch means 50 are provided at opposite sides of terminal 36 by means of a pair of latch wings 54 projecting laterally outwardly from opposite side edges of contact leg 42 and latchingly interengageable with a pair of the latch hooks 52 bent upwardly from opposite side edges of fixing leg 40. It can be seen that the top edges of latch hooks 52 are chamfered so that latch wings 54 can “snap” into latching engagement beneath the latch hooks when contact leg 42 is pushed toward fixing leg 40 to preload the contact leg (and contact portion 46) with a certain preload force.

Fixing leg 40 has a first through hole 56 into which a downwardly or inwardly bent distal end 46a of contact portion 46 can move when the contact portion is pressed downwardly by a memory card. This further allows for a low profile of the overall connector.

Tail portion 48 has a second through hole 58 through which solder material can flow to a top surface of the tail portion. This increases the soldering fastness of the solder connection with a contact on the printed circuit board.

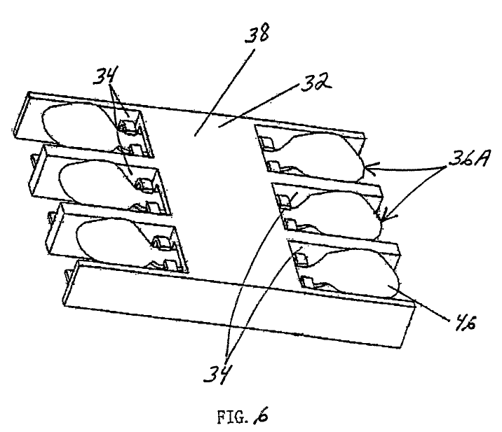

FIGS. 6-8 show a second embodiment of the invention. Like reference numerals have been applied in FIGS. 6-8 corresponding to like components described above in relation to the first embodiment of FIGS. 3-5.

Specifically, a second embodiment of a memory card connector, generally designated 30A, is shown in FIG. 6. The connector includes a dielectric housing 32 having a mating face 38. The housing has a plurality of terminal-receiving slots 34 for receiving a plurality of conductive terminals, generally designated 36A.

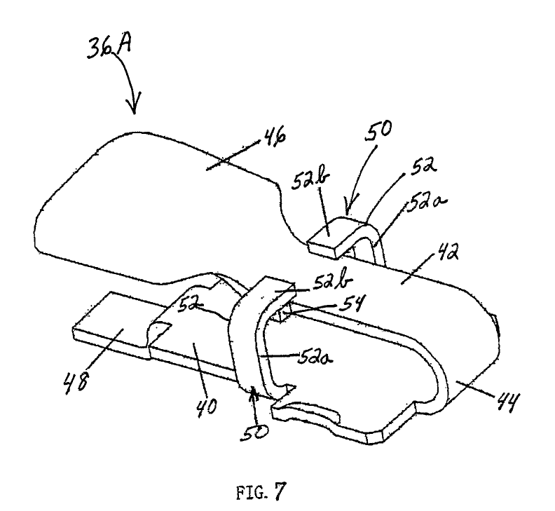

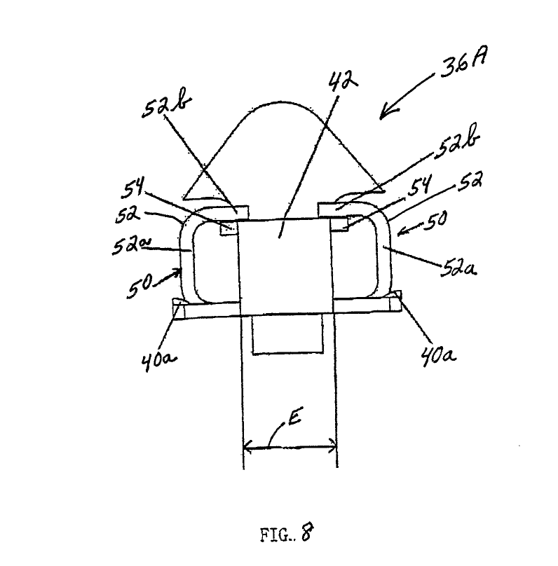

Referring to FIGS. 7 and 8, each terminal 36A includes a generally U-shaped section defining a fixing leg 40 and a contact leg 42 joined by a spring bend 44. Contact leg 42 extends from the spring bend to a distal end which forms a contact portion 46. Fixing leg 40 extends from the spring bend to a distal end which forms a tail portion 48 for connection to an appropriate printed circuit board. The fixing leg has a plurality of teeth 40a to facilitate fixing the terminal in its respective slot 34 in the housing.

Like terminal 36 in FIGS. 4 and 5, terminal 36A in FIGS. 7 and 8 includes a latch means 50 interengaged between fixing leg 40 and contact leg 42, between adjacent side edges of the legs and at both opposite sides of the legs. Specifically, each latch means 50 of terminal 36 includes a generally L-shaped latch hook 52 having a vertical arm 52a and an inwardly bent latch arm 52b. Terminal 36A is stamped and formed of conductive sheet metal material, and latch hooks 52 are formed at opposite side edges of fixing leg 40. Latch arms 52b of latch hooks 52 are bent inwardly over a pair of latch wings 54 which project outwardly from opposite side edges of contact leg 42. Therefore, contact leg 42 and contact portion 46 can be preloaded with a certain preload force by pushing downwardly on the flexible contact leg and moving latch arms 52b of latch hooks 52 inwardly over the tops of latch wings 54.

Referring specifically to FIG. 8, the double-headed arrow “E” represents the width of contact leg 42. It must be kept in mind that terminals 36A (as well as terminals 36) are quite small. By providing wings 54, the gap between the extreme inner ends of latch arms 52b of latch hooks 52 can be sufficiently wide to prevent interference therebetween, while still providing a latching interengagement with latch wings 54. Alternatively, the latch wings could be eliminated, and latch hooks 52 can be staggered lengthwise of contact leg 42 and, thereby, prevent interference between the inwardly directed latch arms. As with the first embodiment, terminals 36A provide a self-contained preloading system in the terminals themselves, thereby eliminating any provisions on the connector housing to preload the terminals.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A memory card connector, comprising:
a dielectric housing having at least one terminal-receiving slot;
a conductive terminal mounted in said slot and including a generally U-shaped section defining a fixing leg and a contact leg joined by a spring bend, the fixing leg being fixed to the housing, and the contact leg being resiliently flexible and having a contact portion for engaging a contact on a memory card; and
latch means interengaged between the fixing leg and the contact leg for preloading the resiliently flexible contact leg with a preload force while allowing the contact leg to flex upon engagement with the memory card.

2. The memory card connector of claim 1 wherein said fixing leg extends from said spring bend to a distal end forming a tail portion for connection to an appropriate printed circuit board.

3. The memory card connector of claim 1 wherein said contact leg extends from said spring bend to a distal end which forms said contact portion.

4. The memory card connector of claim 3 wherein said contact leg is cantilevered over the fixing leg and said contact portion is rounded and projects outwardly from the contact leg.

5. The memory card connector of claim 1 wherein said latch means are interengaged between adjacent side edges of the fixing and contact legs.

6. The memory card connector of claim 1 wherein said latch means comprise a latch hook at a side edge of one of the fixing or contact legs latchingly interengaged with a latch wing projecting from a side edge of the other of the fixing or contact legs.

7. The memory card connector of claim 1 wherein said latch means are interengaged between adjacent side edges of the fixing and contact legs at both opposite sides of the legs.

8. The memory card connector of claim 1 wherein said contact leg has an inwardly bent distal end projecting toward the fixing leg, and the fixing leg has a hole into which the inwardly bent distal end of the contact leg can move upon engagement of the contact leg with the memory card.

9. The memory card connector of claim 1 wherein said fixing leg has a solder tail portion for solder connection to a surface of an appropriate printed circuit board, and the solder tail portion has a through hole through which solder material can flow to a top surface of the solder tail portion.

10. The memory card connector of claim 1 wherein said conductive terminal is stamped and formed of sheet metal material.

11. A memory card connector, comprising:
a dielectric housing having at least one terminal-receiving slot;
a conductive terminal stamped and formed of sheet metal material and mounted in said slot, the terminal including a generally U-shaped section defining a fixing leg and a contact leg joined by a spring bend, the fixing leg being fixed to the housing and extending from the spring bend to a distal end forming a tail portion for connection to an appropriate printed circuit board, the contact leg being resiliently flexible and having a contact portion for engaging a contact on a memory card, and the contact leg being cantilevered over the fixing leg and extending from the spring bend to a distal end forming said contact portion; and
latch means interengaged between adjacent side edges of the fixing leg and the contact leg for preloading the resiliently flexible contact leg with a preload force while allowing the contact leg to flex upon engagement with the memory card.

12. The memory card connector of claim 11 wherein said latch means comprise a latch hook at a side edge of one of the fixing or contact legs latchingly interengaged with a latch wing projecting from a side edge of the other of the fixing or contact legs.

13. The memory card connector of claim 11 wherein said latch means are interengaged between adjacent side edges of the fixing and contact legs at both opposite sides of the legs.

14. The memory card connector of claim 11 wherein the distal end of said contact leg is bent inwardly toward the fixing leg, and the fixing leg has a hole into which the inwardly bent distal end of the contact leg can move upon engagement of the contact leg with the memory card.

15. The memory card connector of claim 11 wherein said tail portion of the fixing leg comprises a solder tail portion for solder connection to a surface of the printed circuit board, and the solder tail has a through hole through which solder material can flow to a top surface of the solder tail.

16. An electrical connector, comprising:
a dielectric housing having at least one terminal-receiving slot;
a conductive terminal mounted in said slot and including a generally U-shaped section defining a fixing leg and a contact leg joined by a spring bend, the fixing leg being fixed to the housing, and the contact leg being resiliently flexible and having a contact portion for engaging a contact on an electrical device; and
latch means interengaged between the fixing leg and the contact leg for preloading the resiliently flexible contact leg with a preload force while allowing the contact leg to flex upon engagement with the electrical device.

17. The electrical connector of claim 16 wherein said fixing leg extends from said spring bend to a distal end forming a tail portion for connection to an appropriate printed circuit board.

18. The electrical connector of claim 16 wherein said contact leg extends from said spring bend to a distal end which forms said contact portion.

19. The electrical connector of claim 18 wherein said contact leg is cantilevered over the fixing leg and said contact portion is rounded and projects outwardly from the contact leg.

20. The electrical connector of claim 16 wherein said latch means are interengaged, between adjacent side edges of the fixing and contact legs.

21. The electrical connector of claim 16 wherein said latch means comprise a latch hook at a side edge of one of the fixing or contact legs latchingly interengaged with a latch wing projecting from a side edge of the other of the fixing or contact legs.

22. The electrical connector of claim 16 wherein said latch means are interengaged between adjacent side edges of the fixing and contact legs at both opposite sides of the legs.

23. The electrical connector of claim 16 wherein said contact leg has an inwardly bent distal end projecting toward the fixing leg, and the fixing leg has a hole into which the inwardly bent distal end of the contact leg can move upon engagement of the contact leg with the memory card.

24. The electrical connector of claim 16 wherein said fixing leg has a solder tail portion for solder connection to a surface of an appropriate printed circuit board, and the solder tail portion has a through hole through which solder material can flow to a top surface of the solder tail portion.

25. The electrical connector of claim 16 wherein said conductive terminal is stamped and formed of sheet metal material.
